(19) United States
(12) Patent Application Publication
(10) Pub. No.: US 2015/0177154 A1
(43) Pub. Date: Jun. 25, 2015

(54) DRY LAMINATED PHOTOLUMINESCENT PROBE AND METHOD OF MANUFACTURE AND USE

(71) Applicant: Dmitri Boris Papkovsky, Blarney County Cork (IE)

(72) Inventor: Dmitri Boris Papkovsky, Blarney County Cork (IE)

(21) Appl. No.: 14/370,865

(22) PCT Filed: Sep. 6, 2011
(86) PCT No.: PCT/EP2011/065422

§ 371 Date: Sep. 4, 2014

(51) Int. Cl. G01N 21/75

(52) U.S. Cl. CPC G01N 21/75

(57) ABSTRACT

Dry laminated photoluminescent probe (10) and methods of manufacture and use. The probe (10) includes a support layer (30) with a plurality of separate and independent optically active particles (20) dry laminated onto a first major surface (30a) of the support layer (30) forming a sensing area (15) on the support layer (30). The optically active particles (20) are preferably laminated onto the support layer (30) via a layer of pressure sensitive adhesive (40).

### BACKGROUND

Solid-state polymeric materials based on target-analyte-sensitive photoluminescent indicator dyes, most commonly oxygen-sensitive indicator dyes, are widely used as optical sensors and probes. See, for example United States Published Patent Applications 2009/0029402, 2008/8242870, 2008/215254, 2008/199360, 2008/190172, 2008/148817, 2008/146460, 2008/117418, 2008/0051646, and 2006/0002822, and U.S. Pat. Nos. 7,569,395, 7,534,615, 7,368,153, 7,138,270, 6,689,438, 5,718,842, 4,810,655, and 4,476,870. Such optical sensors are available from a number of suppliers, including Presens Precision Sensing, GmbH of Regensburg, Germany, Oxysense of Dallas, Tex., United States, and Luxcel Biosciences, Ltd of Cork, Ireland.

These optochemical probes or sensors are typically produced by incorporating a suitable indicator dye in a suitable polymeric matrix. To facilitate handing and reuse while avoiding contamination of the sample, such indicators are often prepared as solid-state coatings, films, layers, dots or stickers applied onto an appropriate substrate.

Coating procedure usually involves preparation of a ‘cocktail’ of the indicator material. Such liquid cocktails typically contain the indicator dye, a carrier polymer, and optionally other desired dyes or additives, all dissolved in a suitable solvent such as ethylacetate, tetrahydrofuran, chloroform, toluene or ethanol. The cocktail is then coated onto a suitable substrate and allowed to dry. Alternatively, the cocktail may replace some or all of the carrier polymer with a precursor polymer which, after coating onto a substrate, is cured with heat, UV light, moisture, etc. Common methods used to apply the cocktail include casting (e.g. with ‘doctor's knife’), spin-coating, spray-coating, jet printing, tampo printing, flexographic printing, soaking the porous substrate in the cocktail, etc. Indicator coatings can be produced either as a continuous film/layer or as localized spots on the substrate.

While generally effective for producing operable probes or sensors, such fabrication techniques suffer from several drawbacks, including (i) the use of additional reagents, solvents, polymer precursors, binder additives, etc. (ii) the need for drying/curing steps which require significant time and increase manufacturing costs, (iii) imperfections in the indicator caused by mechanical stress within the indicator as a result of large volume changes during drying, (iv) solvent compatibility issues between the indicator components, (v) poor adhesion of the indicator coating to the substrate material, (vi) the use and disposal of hazardous substances (i.e. organic solvents), and (vii) poor reproducibility and stability of the indicator coatings.

These factors can have a profound influence on the properties of the resulting probe or sensor, resulting in compromised performance and working characteristics of the finished probes. The probes as tend to have high fabrication costs due to the complexity of the manufacturing process and difficulties encountered in standardizing and controlling all critical parameters, and are often inconvenient to use as significant variability from probe-to-probe results in a frequent need for re-calibration. These drawbacks are compounded when the probes are intended for use as disposable probes in large scale applications, such as non-destructive measurements in sealed containers, such as packaged foods and other products.

Hence, a substantial need exists for a cost effective process and procedure for manufacturing optochemical probes that avoid many of the drawbacks associated with the traditional process of solvent coating indicator dye onto a substrate.

### SUMMARY OF THE INVENTION

A first aspect of the invention is a remotely interrogatable optochemical probe. The probe includes a support layer having a first major surface, and a plurality of separate and independent optically active particles dry laminated onto the first major surface of the support layer whereby the particles form a sensing area on the support layer. The optically active particles are preferably laminated onto the support layer via a layer of pressure sensitive adhesive coated onto the first major surface of the support layer.

A second aspect of the invention is a method of manufacturing the probe of the first aspect of the invention.

A first embodiment of the second aspect of the invention includes the steps of (i) obtaining a support layer having a coating of adhesive on the first major surface, and (ii) depositing the optically active particles onto the surface of the adhesive coating. The method preferably includes the additional step of compressing the deposited optically active particles onto the adhesive.

A second embodiment of the second aspect of the invention includes the steps of (i) obtaining a support layer, (ii) coating adhesive on the first major surface of the support layer, and (iii) sprinkling the optically active particles onto the surface of the adhesive coating. The method preferably includes the additional step of compressively embedding the sprinkled optically active particles into the adhesive.

A third embodiment of the second aspect of the invention includes the steps of (i) obtaining a web of support layer material, (ii) coating adhesive on the first major surface of the web, (iii) depositing the optically active particles onto the surface of the adhesive coating to form a sensing web, and (iv) cutting the sensing web into a plurality of individual remotely interrogatable optochemical probes, each with a sensing area. The method preferably includes the additional step of compressing the deposited optically active particles onto the adhesive prior to cutting the sensing web.

A fourth embodiment of the second aspect of the invention includes the steps of (i) producing optically active particles by obtaining particles of a target-analyte permeable polymer, and impregnating the particles with a target-analyte quenchable photoluminescent material, (ii) obtaining a support layer having a coating of adhesive on the first major surface, and, (iii) sprinkling the optically active particles onto the surface of the adhesive coating. The method preferably includes the additional step of compressively embedding the sprinkled optically active particles into the adhesive.

A third aspect of the invention is a method of monitoring changes in analyte concentration in an environment.

A first embodiment of the third aspect of the invention includes the steps of (i) placing a probe in accordance with the first aspect of the invention into fluid communication with an environment, and (ii) periodically interrogating the probe with an interrogation device wherein interrogations measure changes in the probe reflective of changes in analyte concentration within the environment.

A second embodiment of the third aspect of the invention includes the steps of (i) placing a probe in accordance with the first aspect of the invention into a chamber, (ii) sealing the probe-containing chamber, and (iii) periodically interrogating the probe within the chamber with an interrogation device wherein interrogations measure changes in the probe reflective of changes in analyte concentration within the chamber. The method preferably includes the additional step of placing a test sample into the chamber prior to sealing the chamber, whereby changes in analyte concentration within the chamber are attributable to microbial respiration and/or decomposition of the sample.

### BRIEF DESCRIPTION OF THE DRAWINGS

FIG. 1 is top view of one embodiment of a web of probes in accordance with the first aspect of this invention.

FIG. 2 is an enlarged top view of one of the probes depicted in FIG. 1.

FIG. 3 is a grossly enlarged cross-sectional side view of a portion of the probe depicted in FIG. 2 taken along line 3-3.

FIG. 4 is a grossly enlarged cross-sectional side view of a portion of an optically active particle.

### DETAILED DESCRIPTION OF A PREFERRED EMBODIMENT

### Definitions

As used herein, including the claims, the term “laminated” means layers of material united by an adhesive.

As used herein, including the claims, the phrase “heat resistant” when referring to a pressure sensitive adhesive, means the ability to maintain a bond up to and including the specified elevated temperature.

As used herein, including the claims, the phrase “water resistant” when referring to a pressure sensitive adhesive, means the ability to maintain a bond when submersed in water.

As used herein, including the claims, the phrase “target analyte” means a molecule whose presence-absence is detected and measured. Typical target-analytes are molecular oxygen O₂ and carbon dioxide CO₂.

As used herein, including the claims, the phrase “permeable” means a material that when formed into a 1 mil film has a target-analyte transmission rate of greater than 100 c³/m² day when measured in accordance with ASTM D 3985 when the target analyte is oxygen and when measured in accordance with ASTM D 1434 when the target analyte is other than oxygen.

As used herein, including the claims, the phrase “highly permeable” means a material that when formed into a 1 mil film has a target-analyte transmission rate of greater than 1,000 c³/m² day when measured in accordance with ASTM D 3985 when the target analyte is oxygen and when measured in accordance with ASTM D 1434 when the target analyte is other than oxygen.

### Nomenclature

10 Probe
10′ Web Containing an Array of Probes
15 Sensing Area on Probe
20 Optically Active Particles
21 Target-Analyte-Sensitive Photoluminescent Indicator Dye
22 Target-Analyte-Permeable Carrier Particle
30 Support Layer
30a First or Upper Major Surface of Support Layer
30b Second or Lower Major Surface of Support Layer
40 First Pressure Sensitive Adhesive Layer
50 Protective Cover Layer
60 Second Pressure Sensitive Adhesive Layer
70 Release Liner
100 Packaging or Container
109 Sealed Chamber of Package or Container
200 Analytical Instrument
A Target-Analyte
S Sample

### Description

### Construction

A first aspect of the invention is a probe 10 capable of reporting the partial pressure of a target-analyte A (P_{A}). The probe 10 is inexpensive, self-contained, remotely interrogatable and autonomously positionable, thereby permitting the probe 10 to used for a wide variety of purposes to quickly, easily and reliably measure and monitor changes in analyte concentration in an environment, particularly suited for measuring and monitoring changes in analyte concentration in an enclosed environment in a non-invasive and non-destructive manner.

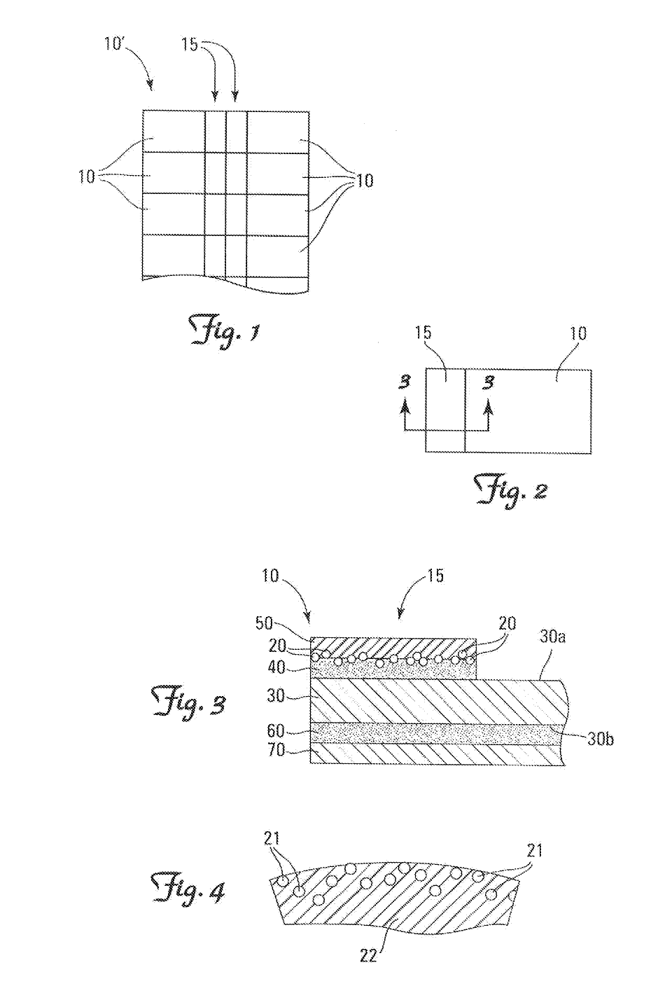

Referring generally to FIGS. 1-4, the probe 10 is comprised of a plurality of separate and independent optically active particles 20 dry laminated onto the first major surface 30a of a support layer 30 via a first layer of a pressure sensitive adhesive 40. The particles 20 form a sensing area 15 on the support layer 30 which may cover all or any portion of the first major surface 30a. A sensing area 15 that covers only a portion of the first major surface 30a may be formed by either pattern coating the first layer of pressure sensitive adhesive 40 onto the first major surface 30a or coating the entire first major surface 30a with the first layer of pressure sensitive adhesive 40 and then pattern coating the optically active particles 20 onto the pressure sensitive adhesive 40.

Each probe 10 preferably has a single discrete sensing area of between 1 and 100 mm², more preferably a single discrete sensing area of between 4 and 30 mm². A sensing area of less than about 1 mm may be susceptible to producing inaccurate readings, while a sensing area of greater than 100 mm results in a significant increase in overall size and cost of the probe 10 without a concomitant increase in performance.

The optically active particles 20 are sensitive to a target-analyte A such as O₂, CO₂, CO or H⁺. For purposes of simplicity only, and without intending to be limited thereto, the balance of the description shall reference O₂ as the target-analyte A since O₂-sensitive probes are the most commonly used types of optically active probes.

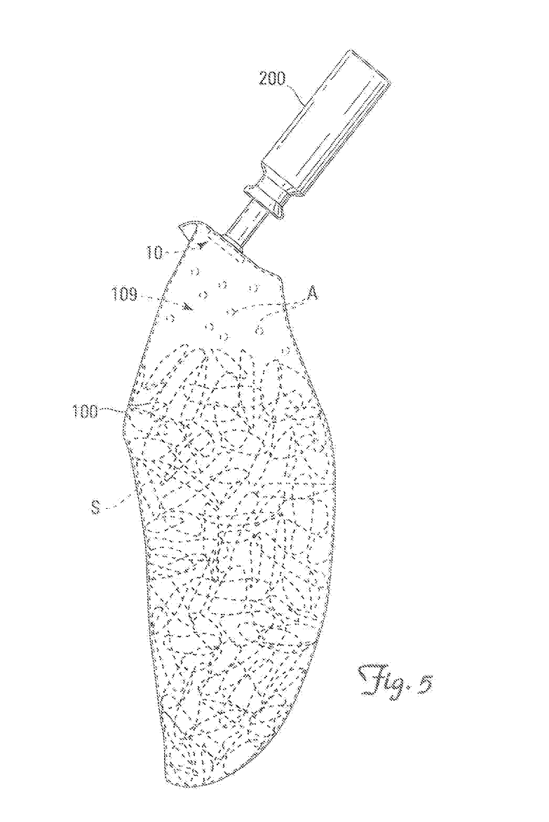

Referring to FIG. 4, the optically active particles 20 are preferably particles containing an O₂ sensitive photoluminescent indicator dye 21 impregnated within an oxygen-permeable polymeric particle 22.

The oxygen-sensitive photoluminescent indicator dye 21 may be selected from any of the well-known P_{O2} sensitive photoluminescent indicator dyes 21. One of routine skill in the art is capable of selecting a suitable indicator dye 21 based upon the intended use of the probe 10. Preferred photoluminescent indicator dyes 21 are long-decay fluorescent or phosphorescent indicator dyes. A nonexhaustive list of suitable P_{O2} sensitive photoluminescent indicator dyes 21 includes specifically, but not exclusively, ruthenium(II)-bipyridyl and ruthenium(II)-diphenylphenanothroline complexes, porphyrin-ketones such as platinum(II)-octaethylporphine-ketone, platinum(II)-porphyrin such as platinum(II)-tetrakis(pentafluorophenyl)porphine, palladium(II)-porphyrin such as palladium(II)-tetrakis(pentafluorophenyl)porphine, phosphorescent metallocomplexes of tetrabenzoporphyrins, chlorins, azaporphyrins, and long-decay luminescent complexes of iridium(III) or osmium(II).

The P_{O2}-sensitive photoluminescent indicator dye 21 can be compounded with or impregnated into a suitable oxygen-permeable carrier particle 22. Again, one of routine skill in the art is capable of selecting a suitable oxygen-permeable carrier particle 22 based upon the intended use of the probe 10 and the selected indicator dye 21. A nonexhaustive list of suitable polymers for use as the oxygen-permeable carrier particle 22 includes specifically, but not exclusively, polystryrene, polycarbonate, polysulfone, polyvinyl chloride, cross-linked poly(styrene-divinylbenzene) and other similar co-polymers.

The optically active particles 20 preferably have an average volume based particle size about 1 to 200 micrometers. The optically active particles 20 most preferably are microparticles have an average volume based particle size about 1 to 10 micrometers. The particles 20 are preferably dry and homogeneous, and may be in the form of beads, fibers, filaments, fines, pellets, powder, prills and the like. Particles 20 of less than about 1 micrometer are difficult to transport and handle during construction of the probe 10, while particles greater than about 200 micrometers tend to delaminate from the support layer 30 after construction of the probe 10, tend to have an undesirably low permeability to target-analyte A and tend to have an undesirably slow response to target-analyte A.

The support layer 30 may be selected from any of the materials commonly employed as a support layer for a P_{O2} sensitive photoluminescent composition. One of routine skill in the art is capable of selecting the material based upon the intended use of the probe 10. A nonexhaustive list of substrates includes specifically, but not exclusively, cardboard, paperboard, polyester Mylar® film, non-woven spinlaid fibrous polyolefin fabrics, such as a spunbond polypropylene fabric. The first major surface 30a of the support layer 30 is preferably configured and arranged to scatter light to provide an efficient excitation of the analyte-sensitive material and collection of its photoluminescence.

In one embodiment, the support layer 30 is preferably between about 30 μm and 500 μm thick and O₂ permeable, most preferably highly O₂ permeable.

For some applications it may be desired to employ a support layer 30 that is O₂ impermeable with an adhesive coating on the second major surface 30b for attachment of the probe 10 to a surface.

The first layer of pressure sensitive adhesive 40 can be coated onto the first major surface 30a of the support material 30 by conventional coating techniques. In order to render the probe 10 suitable for a wide array of customary uses, the first layer of pressure sensitive adhesive 40—and indeed the probe 10 as a whole—is preferably water resistant and heat resistant up to at least 130° C. The pressure sensitive adhesive 40 is also preferably selected to minimize any migration or leaching of indicator dye 21 out from the carrier particle 22 and into the adhesive 40, such as by employing an adhesive 40 with minimal residual solvent.

One of routine skill in the art is capable of selecting a suitable first pressure sensitive adhesive 40 based upon the target analyte A to which the probe 10 is sensitive and the environment likely to be encountered by the probe 10. Generally, acrylic and silicone pressure sensitive adhesives are preferred.

A protective cover layer 50 may be provided over at least the sensing area 15 of the probe 10 for preventing damage to the sensing area 15 during transport and storage. The sensing area 15 is particularly susceptible to damage during transport and storage as many pressure sensitive adhesives are susceptible to accelerated aging and contamination by dust and danger when exposed to the atmosphere. Since the protective cover layer 50 covers the optically active particles 20, the cover layer 50 should be transparent or translucent to radiation at the excitation and emission wavelengths of the indicator dye 21.

The protective cover layer 50 may be selected from any of the well-known materials suitable for such use. One of routine skill in the art is capable of selecting a suitable protective cover layer 50 based upon the intended use of the probe 10. A nonexhaustive list of materials suitable for use as the protective cover layer 50 when the target analyte A is O₂ includes specifically, but not exclusively, polyethylene, polypropylene, silicone, fluorinated poly olefin and polyvinylchloride.

Referring to FIG. 3, the probe 10 preferably includes a second layer of a pressure sensitive adhesive 60 on the second major surface 30b of the support layer 30 for facilitating attachment of the probe 10 to a surface with the sensing area 15 on the probe 10 facing away from the surface. The second layer of pressure sensitive adhesive 60 is preferably covered with a release liner 70 as is customary for purposes of masking the adhesive until just prior to use.

Materials and methods of construction can be selected when desired to render the probe 10 food grade, non-implantable medical grade and/or short term implantable medical grade.

### Manufacture

The optically active particles 20 can be manufactured by any suitable technique. It is generally advantageous for the optically active particles 20 to be microparticles having a uniform size, uniform sensing properties, minimal migration or leaching of indicator dye 21 from the particle 20 and an extended shelf life.

One technique is to dissolve or suspend the indicator dye 21 in a suitable organic solvent such as ethylacetate, immersing resin pellets of the desired type, size and shape—preferably polymeric microbeads—in the solution to impregnated the beads with dye 21, removing the impregnated beads, and allowing the impregnated beads to dry. Alternatively, the solution may be sprayed onto the beads. Generally, the concentration of indicator dye 21 in the organic solvent should be in the range of 0.01 to 5% w/w.

Another technique is to prepare a cocktail which contains the indicator dye 21 and the desired polymer 22 in an organic solvent such as ethylacetate, applying the cocktail to a release liner (not shown), allowing the applied cocktail to dry to form a mass of an optically active composition, removing the mass from the release liner, and milling the mass into particles having the desired size and shape. Generally, the concentration of the polymer 22 in the organic solvent should be in the range of 0.1 to 20% w/w, with the ratio of indicator dye 21 to polymer 22 in the range of 1:50 to 1:5,000 w/w.

Yet another technique is to effect emulsion polymerization of the monomer in the presence of the indicator dye 21 dissolved in the monomer to produce polymeric microparticles 20 impregnated with the dye 21.

The first 40 and second 60 layers of pressure sensitive adhesive can coated onto the first 30a and second 30b major surfaces of the support material 30 respectively by conventional coating techniques known to those of routine skill in the art.

The optically active particles 20 can be deposited onto the first layer of pressure sensitive adhesive 40 by conventional techniques known to those of routine skill in the art. A wide variety of devises for dry coating particulate materials onto a substrate are known and commercially available from a number of sources, such as dry ingredient depositers available from Hinds-Bock of Bothell Wash. The concentration of optically active particles 20 can be diluted with diluents particles, now shown, to reduce cost. The diluent particles can be interspersed with the optically active particles 20 prior to deposit of the particles onto the first layer of pressure sensitive adhesive 40. Preferred diluent particles are particles that are the same as the optically active particles 20 absent indicator dye 21.

The optically active particles 20 can be compressed into the first layer of pressure sensitive adhesive 40 by any conventional technique known to one of routine skill in the art, such as via a nip roller (not shown).

The protective cover layer 50 can be attached to the probe 10 by any convenient technique, with a preference for adhesively laminating the cover layer 50 with the same pressure sensitive adhesive used to laminate the optically active particles 20 onto the support layer 30.

The release liner 70 can be applied by conventional techniques known to one of routine skill in the art, such as via a nip roller (not shown).

Referring to FIG. 1, one of routine skill in the art would also be able to produce a supply of the probes 10 in the form of an array, such as by forming the probes 10 from a continuous web 10′ of the support layer 30.

### Use

Referring generally to FIG. 5, the probe 10 can be used to quickly, easily, accurately and reliably measure the concentration of a target-analyte A in an environment (e.g., the sealed chamber 109 of a package or container 100). The probe 10 can be interrogated in the same manner as typical target-analyte A sensitive photoluminescent probes are interrogated. Briefly, the probe 10 is used to measure the concentration of a target-analyte A in an environment by (A) placing the probe 10 into fluid communication with the environment to be monitored (e.g., within the sealed chamber 109 of a package or container 100) at a location where radiation at the excitation and emission wavelengths of the indicator dye 21 can be transmitted to and received from the optically active particles 20 with minimal interference and without opening or otherwise breaching the integrity of the environment (e.g., the package or container 100), (B) interrogating the probe 10 with an interrogation device 200, and (C) converting the measured emissions to a target-analyte A concentration within the environment based upon a known conversion algorithm or look-up table.

The probe 10 can also be used to quickly, easily, accurately and reliably monitor changes in target-analyte A concentration in an environment by (i) placing the probe 10 into fluid communication with the environment to be monitored (e.g., within the sealed chamber 109 of a package or container 100 containing a sample S) at a location where radiation at the excitation and emission wavelengths of the indicator dye 21 can be transmitted to and received from the optically active particles 20 with minimal interference and without opening or otherwise breaching the integrity of the environment (e.g., the package or container 100), (B) ascertaining the target-analyte A concentration within the environment over time by (i) repeatedly exposing the probe 10 to excitation radiation over time, (ii) measuring radiation emitted by the excited probe 10 after at least some of the exposures, (iii) measuring passage of time during the repeated excitation exposures and emission measurements, and (iv) converting at least some of the measured emissions to a target-analyte A concentration based upon a known conversion algorithm, and (C) reporting at least one of (i) at least two ascertained target-analyte A concentrations and the time interval between those reported concentrations, and (ii) a rate of change in target-analyte A concentration within the environment calculated from data obtained in step (B). Conversion

The radiation emitted by the excited probe 10 can be measured in terms of photoluminescence intensity and/or lifetime (rate of decay, phase shift or anisotropy), with measurement of lifetime generally preferred as a more accurate and reliable measurement technique when seeking to establish the extent to which the indicator dye 21 has been quenched by oxygen.

### EXAMPLES

### Example 1

### O₂ Probe Fabrication

Poly(styrene-co-divinylbenzene) microspheres with an average particle size of 8 micron purchased from Sigma-Aldrich Co. LLC were suspended (10 mg/ml) in chloroform containing 0.1 mg/ml of PtPFPP dye and incubated for 24 hours at 40° C. with shaking to impregnate the microparticles with the dye. Solvent was decanted from the dye impregnated microparticles and the microparticles washed with hexane and dried under vacuum to produce O₂-sensitive polymeric materials in the form of a dry powder. The O₂-sensitive powder was applied in small aliquots (˜1 mg each) onto the surface of polymeric pressure sensitive adhesive tape manufactured by 3M using a powder dispenser. External pressure was applied as required to ensure bonding of the O₂-sensitive microparticles to the tape to create a continuous web of planar O₂-sensitive probes, each with a discrete area of microparticles forming a sensing area on the tape. A protective polyethylene film was applied over the microparticle-containing adhesive surface of the tape.

1. A remotely interrogatable optochemical probe which produces a specific measurable optical response to a target analyte from which target analyte can be reliably quantified, the probe comprising:
(a) a support layer having a first major surface,
(b) a first layer of pressure sensitive adhesive coated onto the first major surface of the support layer, and
(c) a plurality of separate and independent optically active particles sensitive to a target analyte, dry laminated and pattern deposited onto the first major surface of the support layer via the first layer of pressure sensitive adhesive coated onto the first major surface of the support layer, so as the form at least one discrete sensing area on the first major surface of the support layer with areas of pressure sensitive adhesive still exposed.

2. The probe of claim 1 further comprising a plurality of separate and independent diluent particles interspersed with and dry laminated onto the first major surface of the support layer along with the optically active particles.

3. (canceled)

4. The probe of claim 1 further comprising a protective layer covering at least the sensing area.

5. The probe of claim 1 wherein the support law has a second major surface opposite the first major surface, and the probe further comprises a second layer of pressure sensitive adhesive coated onto the second major surface of the support layer.

6. The probe of claim 5 further comprising a release liner covering the second layer of pressure sensitive adhesive.

7. (canceled)

8. The probe of claim 4 wherein the optically active particles are sensitive to concentration of oxygen in communication with the particles and the protective layer is permeable to oxygen.

9. (canceled)

10. (canceled)

11. The probe of claim 1 wherein the support layer is highly permeable to oxygen.

12. (canceled)

13. The probe of claim 1 wherein the first major surface of the support layer scatters light.

14. The probe of claim 1 wherein the adhesive forms a continuous coating over the entire first major surface of the support layer.

15. (canceled)

16. (canceled)

17. (canceled)

18. The probe of claim 1 further comprising a protective layer covering at least the sensing area and a portion of the exposed adhesive area, whereby the protective layer is laminated to the support layer via the first layer of pressure sensitive adhesive.

19. (canceled)

20 The probe of claim 1 wherein the sensing area is a single discrete area of between 1 and 100 mm².

21. (canceled)

22. The probe of claim 1 wherein the sensing area is a single discrete area of between 4 and 30 mm².

23. (canceled)

24. The probe of claim 1 wherein the optically active particles are particles of a target-analyte permeable polymer impregnated with a target-analyte quenchable photoluminescent material.

25. The probe of claim 24 wherein the target-analyte quenchable photoluminescent material is a target-analyte quenchable long-decay fluorescent or phosphorescent indicator dye.

26. (canceled)

27. (canceled)

28. (canceled)

29. The probe of claim 25 wherein the target-analyte permeable polymer is an oxygen permeable polymer selected from polystyrene and cross-linked poly(styrene-divinylbenzene).

30. (canceled)

31. The probe of claim 1 wherein the average volume based particle size of the optically active particles is 1 to 200 micrometers.

32. (canceled)

33. (canceled)

34. The probe of claim 8 wherein the oxygen permeable protective layer covers at least the sensing area, and is selected from a film of polyethylene, polypropylene, silicon, fluorinated polyolefin and polyvinylchloride

35. (canceled)

36. (canceled)

37. The probe of date 24 wherein (i) the target-analyte quenchable photoluminescent material is excited by light at an excitation wavelength and emits light at an emission wavelength, and (ii) both the substrate and pressure sensitive adhesive transmit light at the excitation and emission wavelengths.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A method of monitoring changes in analyte concentration in an enclosed environment, comprising the steps of:
(a) placing a probe is accordance with claim 1 into a chamber,
(b) sealing the probe-containing chamber,
(c) periodically interrogating the probe within the chamber with an interrogation device wherein interrogations measure changes in the probe reflective of changes in analyte concentration within the chamber.

52. The method of claim 51 wherein a test sample is placed into the chamber prior to sealing the chamber whereby changes in analyte concentration within the chamber are attributable to microbial respiration and/or decompositions of the sample

53. (canceled)
